(19) United States
(12) Patent Application Publication
(10) Pub. No.: US 2011/0128873 A1
(43) Pub. Date: Jun. 2, 2011

(54) Ultra Large Cell Communications

(76) Inventor: Emad N. Farag, Flanders, NJ (US)

(21) Appl. No.: 12/952,386

(22) Filed: Nov. 23, 2010

Related U.S. Application Data
(60) Provisional application No. 61/283,095, filed on Nov. 27, 2009.

(51) Int. Cl. H04W 24/00

(52) U.S. Cl. 370/252

(57) ABSTRACT

To address the need for new techniques that are able to support communications in ultra large cells various embodiments are described. For example, one method involves determining that user equipment (UE) is located in a far zone of a transceiver node's coverage area and then determining a timing advance value for the UE such that a transmission from the UE will be received at the transceiver node one slot period after a transmission of a near zone UE assigned to the same HARQ process. This timing advance value is then indicated to the UE.

### REFERENCE(S) TO RELATED APPLICATION(S)

The present application claims priority from a provisional application, Ser. No. 61/283,095, entitled “Ultra Large Cell Support in LTE,” filed Nov. 27, 2009, which is commonly owned and incorporated herein by reference in its entirety.

### FIELD OF THE INVENTION

The present invention relates generally to communications and, in particular, to wireless communication systems.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

In the present LTE standard, the time offset adjustment is limited to a round trip delay corresponding to a cell radius of 100 Km. In certain locations, a cell radius greater than 100 Km may be desirable. Thus, new solutions and techniques that are able to overcome this LTE cell-size limitation would meet a need and advance wireless communications generally.

### BRIEF DESCRIPTION OF THE DRAWINGS

FIG. 1 is a block diagram depiction of a LTE Physical Random Access Channel.

FIG. 2 is a block diagram depiction of RACH signal extraction in an LTE system.

FIG. 3 is a block diagram depiction of an uplink time budget in an LTE system.

FIG. 4 is a block diagram depiction of the extraction of two sequences from the received signal.

FIG. 5 is a block diagram depiction of how orthogonality may be retained between near zone UEs and far zone UEs.

FIG. 6 is a block diagram depiction of uplink (UL) timing at the eNB.

FIG. 7 is a block diagram depiction of downlink (DL) timing at the eNB.

FIG. 8 is a block diagram depiction of the impact of far zone/near zone UEs sharing the same PRB on transmission efficiency.

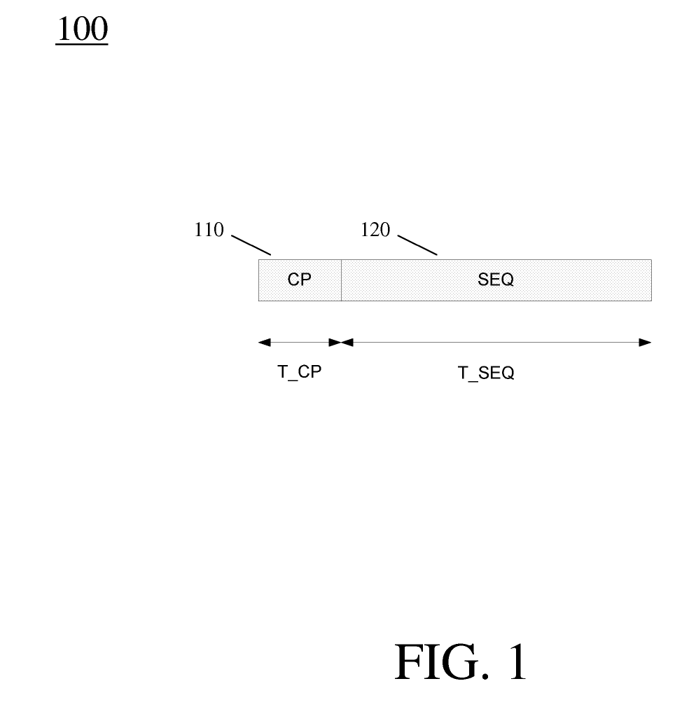

Specific embodiments of the present invention are disclosed below with reference to FIGS. 1-8. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

To provide a greater degree of detail in making and using various aspects of the present invention, a description of our approach to supporting communications in ultra large cells and a description of certain, quite specific, embodiments follows for the sake of example. FIGS. 1-8 are referenced in an attempt to illustrate some examples of specific embodiments of the present invention and/or how some specific embodiments may operate.

An ultra large cell is defined as a cell having a radius greater than 100 Km. An LTE cell includes a base station (also called eNB) located at the center of the cell and users terminals (also called UEs) distributed throughout the cell. Users in an ultra large cell are classified into

near zone users (these are the users within 100 Km of the center of the cell (eNB)) and

far zone users (these are the users with a distance greater than 100 Km from the center of the cell (eNB)).

Below, we describe the uplink transmission scheme used in LTE, and we focus on the PRACH channel, which is used by the radio access network to detect a transmission from a user and to determine the location of the user within the cell. We also describe the basic principles of the Physical Uplink Shared Channel (PUSCH), illustrating the importance of orthogonality in the uplink between the users of the cell and how orthogonality is maintained. We then present a technique that allows the detection of users in an ultra large cell. The basic approach is to use multiple PRACH search ranges and post process the search results to determine the position of the user in the cell. In addition, we present a technique that can be used for the PUSCH and PUCCH channels to retain orthogonality between near zone and far zone users.

### LTE Uplink Transmission

There are three uplink physical channels defined in the LTE standard:

PRACH. This is the Physical Random Access Channel. This channel is used by the user for initial registration, handover and to request a grant to send uplink data after a period of inactivity. The eNB uses this channel to determine the user's location.

PUSCH. This is the Physical Uplink Shared Channel. This channel is used by the user to send the uplink shared channel as well as uplink control information.

PUCCH. This is the Physical Uplink Control Channel. This channel is used by the user to send uplink control information, such as the Ack/Nack response for downlink transmission, the downlink channel quality indicator and the uplink scheduling request.

The Physical Random Access Channel includes two parts as shown in diagram 100 of FIG. 1; the cyclic prefix 110, this has a duration T_{CP} and the preamble sequence 120, this has a duration T_{SEQ}. Different preamble formats are defined in the standard depending on the duration of T_{CP} and T_{SEQ} as given by Table 1.

TABLE 1
Random Access Preamble Formats

| Preamble Format | T_{CP} | T_{SEQ} | |
|---|---|---|---|
| Format 0 | 3168 Tₛ | 24576 | Tₛ |
| Format 1 | 21024 Tₛ | 24576 | Tₛ |
| Format 2 | 6240 Tₛ | 2 × 24576 | Tₛ |
| Format 3 | 21024 Tₛ | 2 × 24576 | Tₛ |
| Format 4 (TDD only) | 448 Tₛ | 4096 | Tₛ |

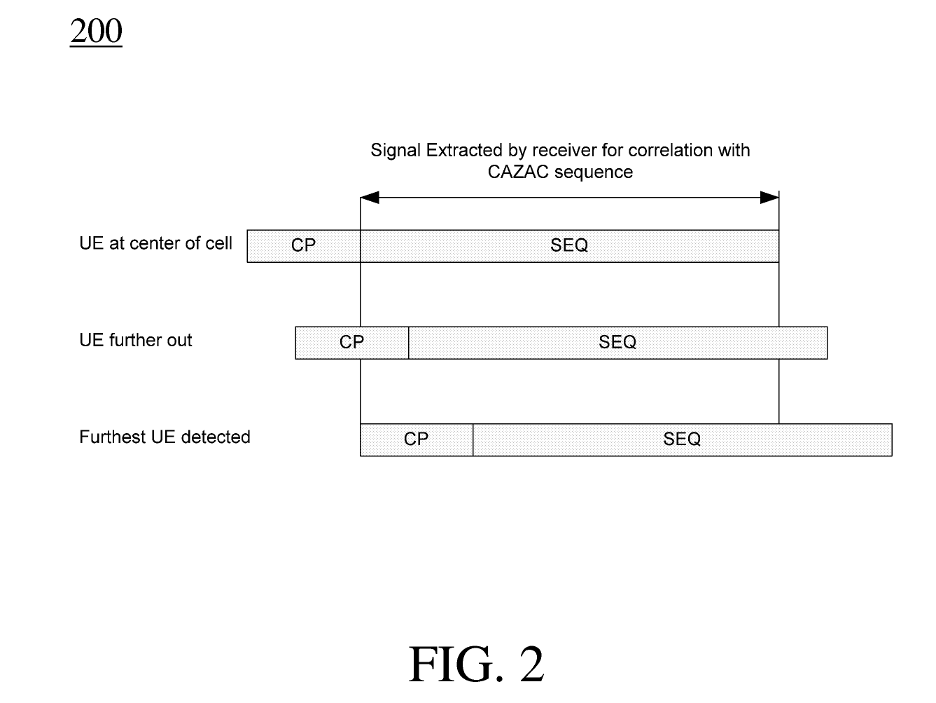

The RACH preamble detector in the eNB typically involves extracting from the received signal a sequence equal in length to the RACH preamble sequence and circularly correlating this with the CAZAC sequence of the preamble root sequence. The resulting correlation peaks determine the users' locations. As shown in diagram 200 of FIG. 2, when the UE is at the center of the cell (at the foot of the eNB), the extracted sequence consists of the preamble sequence transmitted by the UE. As the UE moves further from the eNB, the extracted signal consists of part of the CP and part of the preamble sequence. When the UE is far enough, the extracted sequence consists of the full CP and part of the preamble sequence, any further movement of the UE away from the cell center results in only part of the signal transmitted by the UE being extracted at the eNB for correlation with the reference signal. This leads to degradation in the quality of detection. Hence, the RACH preamble cyclic prefix determines the cell radius. For RACH preamble formats 1 and 3, the CP duration is 21024 Tₛ, which is approximately 684 usec, which corresponds to a cell radius of about 100 Km. Below, we explore an approach to extend the search range of the PRACH beyond 100 Km.

The LTE standard uses SC-FDMA (Single Carrier-Frequency Division Multiple Access) as the access scheme in the uplink for the PUSCH and PUCCH channels. To maintain orthognality in the uplink, all uplink transmissions from different users are required to arrive at the eNB at the same time. Maintaining user orthogonality at the eNB receiver is an important aspect of LTE, as it minimizes inter-user interference and simplifies the receiver structure, for example, by using a single FFT engine to transform the received signal of all users into the frequency domain and performing user separation and equalization in the frequency domain.

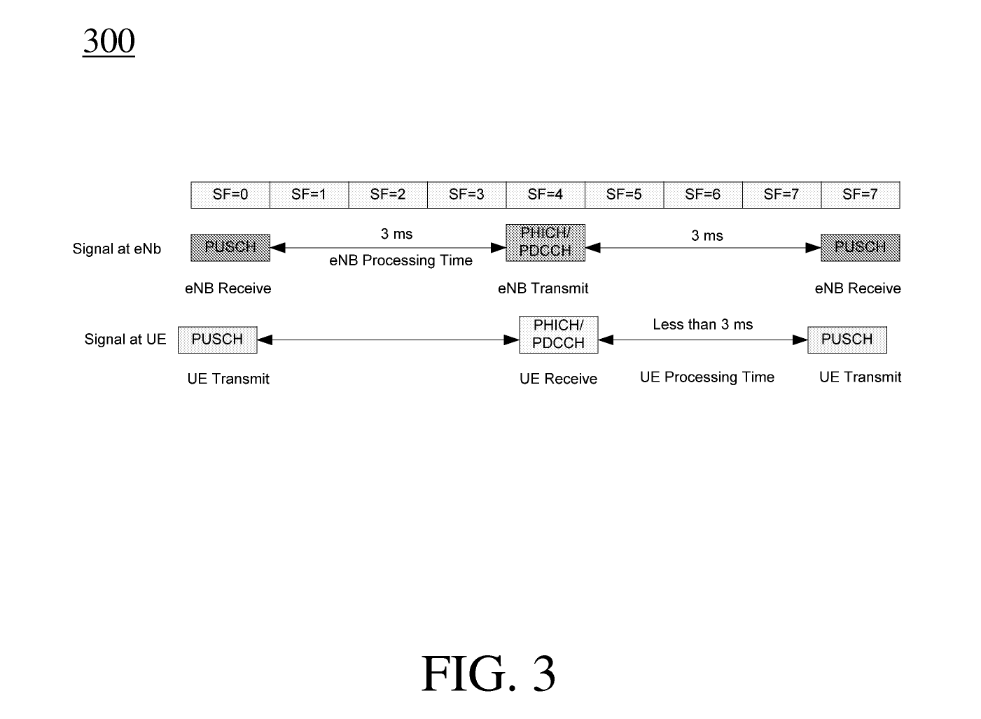

In LTE, synchronous HARQ is used in the uplink. The time between an uplink transmission and a re-transmission or a new transmission on the same HARQ process is 8 sub-frames for FDD, as shown in diagram 300 of FIG. 3. Of these 8 subframes, 3 subframes are allocated for the eNB processing, 3 subframes are allocated for the UE processing and 2 subframes are allocated for the transmission of the uplink and downlink subframes. The over-the-air propagation delay reduces the processing time in the UE (and possibly in the eNB).

To be aligned at the eNB receiver implies that users further away from the base station advance their transmission time more than users closer to the eNB. Each user can advance or retard its uplink transmission time based on a time advance command sent by the eNB. A user at the center of the cell would be expected to advance its time by 0 usec. In this case, the UE gets the full 3 ms to process the uplink grant sent on PDCCH and transmit the corresponding UL PUSCH data packet. As the UE gets further away from the base station, it needs to advance its transmission time by an amount equal to the round trip propagation delay to compensate for the propagation time. This reduces the time the UE has to process the UL grant sent on PDCCH and transmit the corresponding UL PUSCH data packet. As a result there is a limit on the amount of time advance the UE can perform. This is limited to 1282*16 Ts, as defined in the standard, which equals 667.7 usec, and corresponds to a cell radius of about 100 Km. Below, we present an approach to maintain orthogonality between users in an ultra large cell, having a cell radius larger than 100 Km, while respecting the UEs capabilities as defined by the 3GPP standard of being able to adjust its uplink time by 667.7 usec.

### User Detection Over Ultra Large Cells

The PRACH channel is used to determine the position of a user in the cell. As explained above, the duration of the PRACH Cyclic Prefix (CP) determines the cell radius. For the preamble formats with the largest CP, the cell radius supported is about 100 Km. Here we present an approach for using the PRACH channel to determine the position of a user beyond 100 Km.

To support the detection and determination of the UE position beyond 100 Km, multiple PRACH correlations are performed. In this example, we consider preamble format 1 as given by Table 1. However, this approach can be extended to any other preamble format. For preamble format 1 we have:

T_{CP}=684 μsec

T_{SEQ}=800 μsec

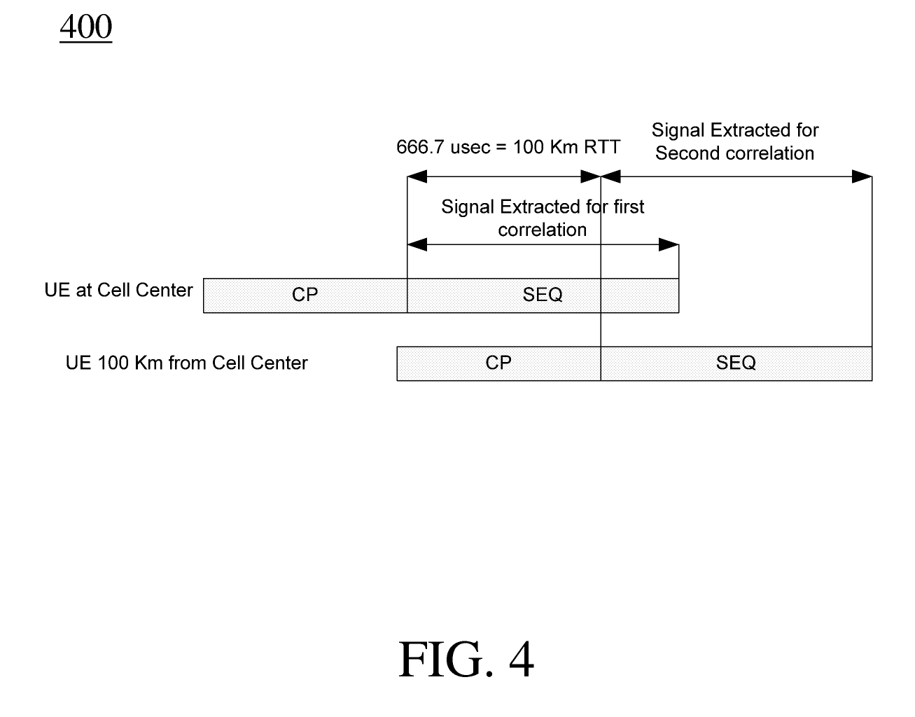

We extract two sequences from the received signal; this is shown in diagram 400 of FIG. 4. Both sequences have a duration of 800 μsec. The first sequence starts at the end of the CP of the user located at the center of the cell. The second sequence starts 666.7 μsec later, which corresponds to the end of the CP of the user located 100 Km from the center of the cell. Both sequences are circularly correlated with the CAZAC sequence of the corresponding root sequence having a length of 800 μsec. Because of the circular correlation and the sequence length of 800 μsec, each user in the range of 0 to 120 Km has a distinct peak, after that the correlation peaks wrap around and fall on top of each other.

Now lets consider a UE at a distance d from the center of the cell such that d<102 Km. 102 Km corresponds to the round trip delay of 684 μsec, which is the CP duration of preamble format 1. This UE's PRACH signal is completely covered by the first circular correlation, the peak resulting from the first correlation gives the position of the UE from the center of the cell (d). For the second circular correlation, only part of this UE's signal is covered (except if d in the range of 100 km to 102 km). In this case, the peak resulting from the second correlation is located at (d−100) % 120. However, since the UE's signal is only partly covered by the second correlation, we expect the peak of the second correlation to be less than the peak of the first correlation.

Now lets consider a UE at a distance d from the center of the cell such that d>100 Km. This UE's PRACH signal is partly completely covered by the first circular correlation (except if d in the range of 100 Km to 102 Km), the peak resulting from the first correlation gives the position of the UE from the center of the cell modulo 120 Km (d % 120). For the second circular correlation, the UE's entire signal is covered by the correlation. In this case, the peak resulting from the second correlation is located at (d−100) % 120. However, since the UE's signal is only partly covered by the first correlation, we expect the peak of the first correlation to be less than the peak of the second correlation.

### Algorithm Description:

| | |
|---|---|
| 1. | Let's assume that there is a peak in the first circular correlation at |
| | position d1, with magnitude M1. |
| | Calculate the corresponding position in the second circular |
| | correlation d2: |
| | d2 = (d1 − 100)% 120 |
| | Let M2 be the magnitude corresponding to d2. |
| | If (M1 > M2) |
| | UE is located at position d1 from the center of the cell. |
| | Else (M2 > M1) |
| | UE is located at position d2 + 100 from the center of the cell. |
| 2. | Let's assume that there is a peak in the second circular correlation |
| | at position d2, with magnitude M2. |
| | Calculate the corresponding position in the first circular |
| | correlation d1: |
| | d1 = (d2 − 100)% 120 |
| | Let M1 be the magnitude corresponding to d1. |
| | If (M1 > M2) |
| | UE is located at position d1 from the center of the cell. |
| | Else (M2 > M1) |
| | UE is located at position d2 + 100 from the center of the cell. |

### Maintaining Orthogonality Throughout an Ultra Large Cell

As described above, the UE can only adjust its timing by 667.7 μsec. Hence a far zone UE would not be able to advance its time enough to compensate for the round-trip propagation delay, as a result the signals of these UEs arrive too late. The implication of this is that the signal of a far zone UE will not be orthogonal to the signal of the near zone UEs.

To avoid the loss of orthogonality for far zone UEs, those UEs are allowed to have their signal retarded by 1 slot (half a subframe) at the eNB receiver from the signal of the near zone UEs assigned to the same HARQ process, this guarantees orthogonality. In this case, we have slot alignment between the near zone UEs and the far zone UEs. The time advance command is used to adjust the far zone UE's time of transmission to guarantee that the signal received at the eNodeB is delayed by one slot from that of the near zone UEs.

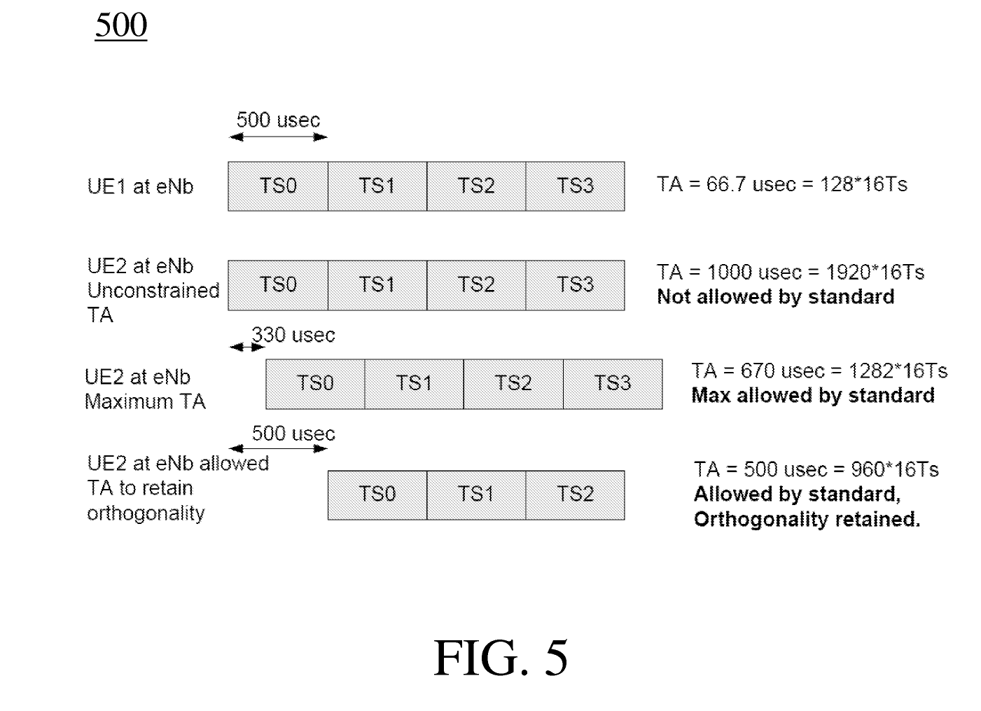

Diagram 500 of FIG. 5 depicts an example of how orthogonality is retained between near zone UEs and far zone UEs. Consider two UEs in an extended LTE cell. One UE is at 10 Km from the base station and the second UE is at 150 Km from the base station. To align the signal of both UEs at the base station antenna and for that matter any UE in the cell, the transmission time of the first UE needs to be advanced by the round trip time of 10 Km, which is 66.7 usec 128*(16 Ts). 16 Ts is the smallest increment by which the UE's time can be adjusted by in LTE. The second UE needs to adjust its time by 1000 usec 1920*(16 Ts) to be aligned with other UEs at the base stations antenna. This violates the LTE standard, where the maximum allowed time adjustment for each UE is 1282*(16 Ts). If the second UE adjusts its timing by 1282 Ts (˜670 usec) (maximum allowed by the standard), it is no longer aligned with the first UE. This destroys the principle of orthogonality between users at the base station receiver, which in turn leads to a significant loss in performance. Instead of adjusting its time by 1282*(16 Ts), the second UE adjusts its time to make it slot aligned with the first UE. This makes the two UEs orthogonal and hence no impact on performance. However, in this case, the second UE is delayed by 1 time slot compared to the first UE. The second UE will have its time adjusted by 960*(16 Ts). Note that slot alignment was chosen over symbol alignment for users, as in the Normal CP case, symbols have different durations. In the extended CP case, we could chose symbol alignment.

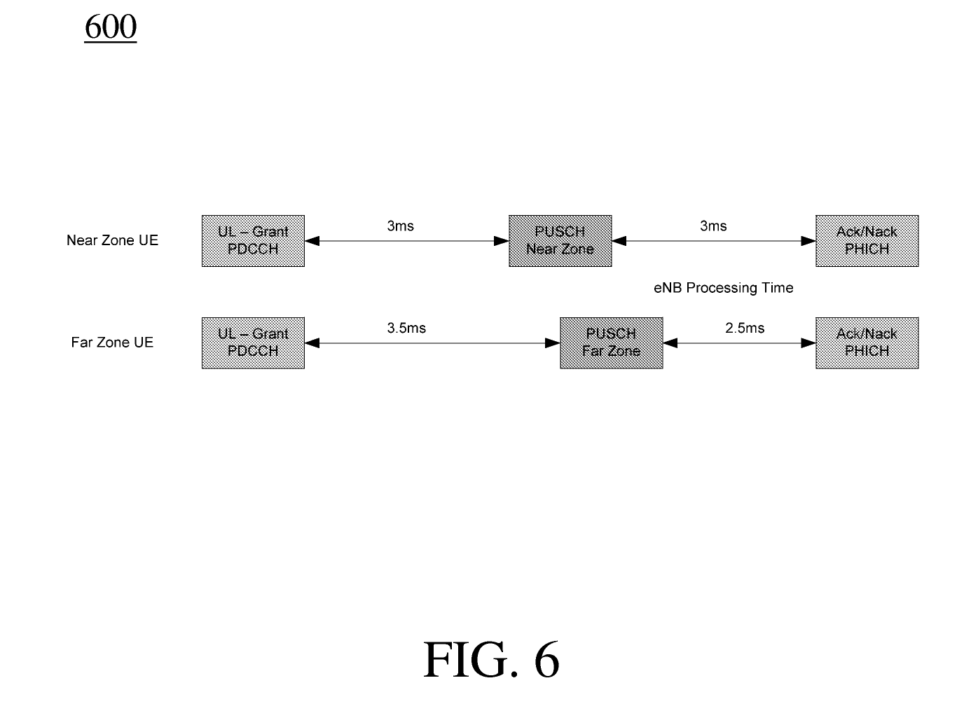

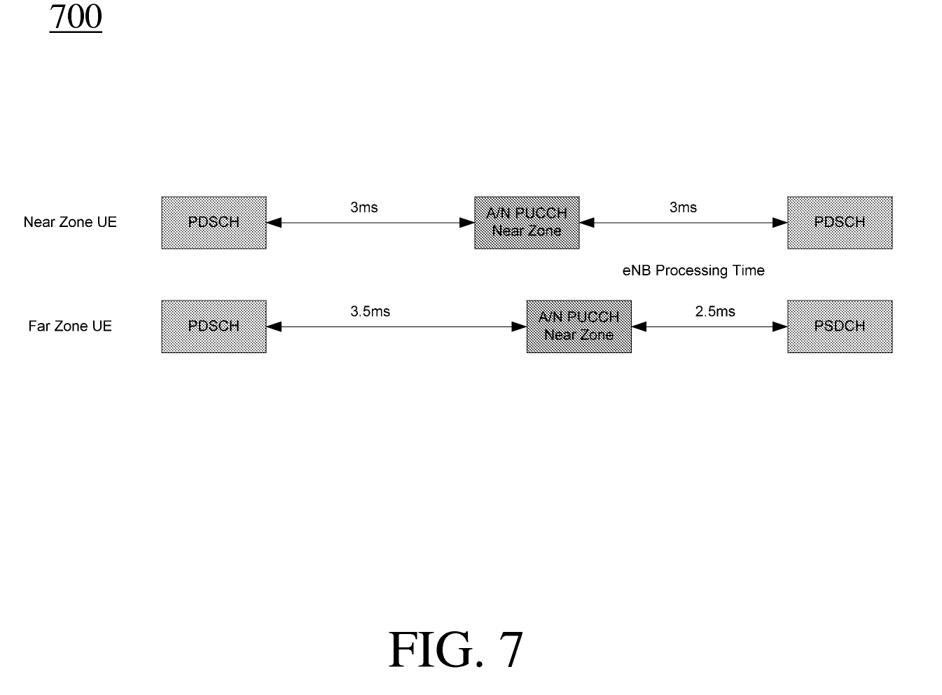

Diagrams 600 and 700 of FIGS. 6 and 7 show the UL and DL HARQ timing at the eNB. Because transmissions from the far zone UEs are delayed by one time slot at the eNB receiver for both PUSCH and PUCCH, the eNB processing budget is reduced by 0.5 ms, from 3 ms to 2.5 ms.

### Practical Considerations

For a far zone UE, the processing time in the eNB is reduced by one time slot relative to the processing time of a near zone UE. Near zone UEs have 3 ms eNB processing time budget, while far zone UEs have 2.5 ms eNB processing time budget.

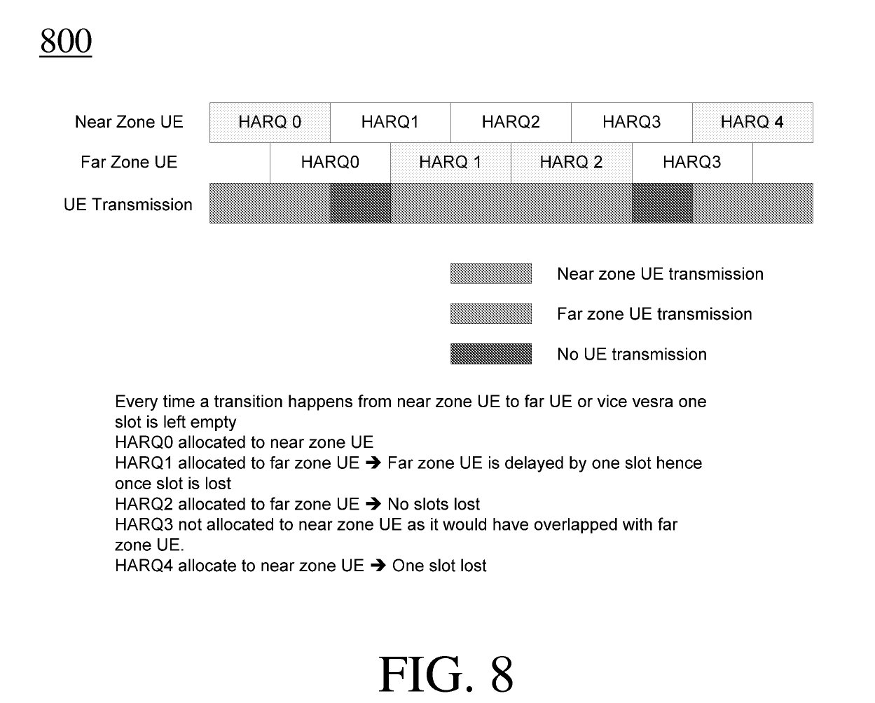

The signal of far zone UEs is delayed by one slot from that of the near zone UEs. This means that when we change a PRB allocation from a far zone UE to a near zone we lose one slot as we have to delay the PRB allocation of the near zone UE by one HARQ process. Similarly when we change PRB allocation from a near zone UE to a far zone UE, we lose one slot. This is shown in diagram 800 of FIG. 8.

To minimize the loss of transmission time, some PRBs should be allocated exclusively to near zone UEs, while other PRBs get allocated exclusively to far zone UEs; that is, avoid PRBs that get allocated to a mix of near zone and far zone UEs as this leads to loss of transmission time when transitioning from near zone UEs to far zone UEs or vice versa.

Another option to consider is to allow transmissions of near zone UEs and far zone UEs to over lap, and use interference cancellation mechanisms to separate the overlapping parts of the signal.

The PUCCH transmission of the near and far zone UEs can also over lap. To avoid overlap different cyclic shifts can be allocated to PUCCH transmissions used for CQI and SR to near zone and far zone UEs. The Ack/Nack cyclic shift on PUCCH is determined the CCE number used in the corresponding DL PDCCH transmission. Care should be exercised in the DL scheduler to avoid using PDCCH channels for near zone and far zone users that lead to the same cyclic shift in overlapping PUCCH transmissions.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method comprising:
determining that user equipment (UE) is located in a far zone of a transceiver node's coverage area;
determining a timing advance value for the UE such that a transmission from the UE will be received at the transceiver node one slot period after a transmission of a near zone UE assigned to the same HARQ process;
indicating to the UE the timing advance value determined.

2. The method of claim 1, wherein determining that the UE is located in the far zone comprises:
performing multiple access channel correlations.

3. The method of claim 1, wherein performing multiple access channel correlations comprises:
performing multiple Physical Random Access Channel (PRACH) correlations.

4. The method of claim 1, wherein indicating to the UE the timing advance value determined comprises:
sending a time advance command to the UE.

5. The method of claim 1, further comprising
reserving certain PRBs for allocation to far zone UEs and certain other PRBs for allocation to near zone UEs.

6. An article of manufacture comprising a processor-readable storage medium storing one or more software programs which when executed by one or more processors performs the steps of the method of claim 1.

7. A transceiver node of a communication system, the transceiver node being configured to communicate with other devices in the system, wherein the transceiver node is operative
to determine that user equipment (UE) is located in a far zone of the transceiver node's coverage area,
to determine a timing advance value for the UE such that a transmission from the UE will be received at the transceiver node one slot period after a transmission of a near zone UE assigned to the same HARQ process, and
to indicate to the UE the timing advance value determined.

8. The transceiver node of claim 7, wherein being operative to determine that the UE is located in the far zone comprises:
being operative to perform multiple access channel correlations.

9. The transceiver node of claim 8, wherein being operative to perform multiple access channel correlations comprises:
being operative to perform multiple Physical Random Access Channel (PRACH) correlations.

10. The transceiver node of claim 7, wherein being operative to indicate to the UE the timing advance value determined comprises:
being operative to send a time advance command to the UE.

11. The transceiver node of claim 7, being further operative to
reserve certain PRBs for allocation to far zone UEs and certain other PRBs for allocation to near zone UEs.
